(19) United States
(12) Patent Application Publication
(10) Pub. No.: US 2026/0364617 A1
(43) Pub. Date: Nov. 19, 2026

(54) SPRINKLER HAVING A DISTRIBUTION PLATE WITH A FLOW DEFLECTOR

(71) Applicant: Hunter Agriculture Incorporated, San Marcos, CA (US)

(72) Inventors: Jay C. Huberty, Orlando, FL (US); Gregory S. Burcham, Falkville, AL (US); Allison Daniel, Melbourne, FL (US)

(21) Appl. No.: 19/133,678

(22) PCT Filed: Dec. 13, 2023
(86) PCT No.: PCT/US2023/083903

§ 371 Date: May 28, 2025

Related U.S. Application Data
(60) Provisional application No. 63/387,351, filed on Dec. 14, 2022.

(51) Int. Cl. B05B 1/26; B05B 3/02; B05B 3/04

(52) U.S. Cl. CPC B05B 1/26; B05B 3/02; B05B 3/04

(57) ABSTRACT

A sprinkler assembly includes a water inlet and a nozzle in fluid communication with the water inlet and positioned downstream of the water inlet. The sprinkler can further include a bearing positioned downstream of the nozzle and a deflector assembly. The deflector assembly can include a distribution plate configured to deflect water from the nozzle in opposite directions. For example, the distribution plate can include first and second grooves which deflect the water along an arching flowpath and a radial flowpath, respectively.

### CROSS-REFERENCE TO RELATED APPLICATION

This application claims benefit under 35 U.S.C. 119(e) to U.S. Provisional Patent App. No. 63/387,351, filed Dec. 14, 2022, the entire disclosure of which is hereby incorporated by reference herein in its entirety. Any and all priority claims identified in the Application Data Sheet, or any corrections thereto, are hereby incorporated by reference under 37 CFR 1.57.

### FIELD

The present disclosure relates to apparatuses for irrigating turf, agriculture, and/or landscaping.

### BACKGROUND

In many parts of the world, rainfall can be insufficient and/or too irregular to keep turf and landscaping green and/or to sufficiently water crops and other agricultural products. Therefore, irrigation systems are often installed to provide adequate irrigation to landscaping and/or agricultural products.

### SUMMARY

The present disclosure is directed to a sprinkler assembly. An aspect of the disclosure is a sprinkler assembly that includes a water inlet, a frame connected to the water inlet, a nozzle in fluid communication with the water inlet and positioned downstream of the water inlet, the nozzle configured to direct water out of the nozzle along a nozzle axis, a bearing positioned downstream of the nozzle and supported by the frame, and a deflector assembly between the nozzle and the bearing and being supported by the bearing. The deflector assembly includes a distribution plate configured to deflect water from the nozzle. The distribution plate is positioned downstream of the nozzle and includes a first groove configured to receive water from the nozzle at a drive inlet and deflect a first portion of the water along an arcing flowpath extending radially away from the nozzle axis to a drive outlet that generates a first torque in a first direction, a second groove configured to receive water from the nozzle at a spray inlet and deflect a second portion of the water along a radial flowpath to a spray outlet, and a flow deflector in the second groove that generates a second torque in a second direction opposite the first direction when the second portion of the water flows past.

Additional aspects further comprise wherein the second torque is less than the first torque so that overall the distribution plate rotates in the first direction.

Additional aspects further comprise wherein the distribution plate comprises a plurality of the first grooves and a plurality of the second grooves.

Additional aspects further comprise wherein the flow deflector projects upwardly from a bottom surface at or near the spray outlet of the second groove.

Additional aspects further comprise wherein the second portion of the water passes over and around the flow deflector to produce the second torque.

Additional aspects further comprise a shroud covering at least a portion of the frame.

Additional aspects further comprise wherein the nozzle is removably coupled to the shroud.

Additional aspects further comprise a receiving station supported by the shroud, the receiving station being configured to hold a spare nozzle.

Additional aspects further comprise wherein the frame comprises a plurality of arms supporting the bearing.

Additional aspects further comprise wherein the distribution plate is configured to rotate and tilt about the nozzle axis, and wherein the distribution plate is configured to disperse water in different directions to facilitate a more even water distribution.

Additional aspects further comprise a drive brake assembly configured to resist rotation of the distribution plate.

Additional aspects further comprise wherein the drive brake assembly is configured as a viscous shear brake.

Another aspect of the disclosure is a sprinkler assembly that includes a water inlet, a frame connected to the water inlet, a nozzle in fluid communication with the water inlet and positioned downstream of the water inlet, the nozzle configured to direct water out of the nozzle along a nozzle axis, and a distribution plate configured to deflect water exiting the nozzle. The distribution plate includes a first groove configured to receive some of the water from the nozzle and generate a first torque in a first direction, and a second groove comprising a flow deflector, the flow deflector projecting upwardly from a bottom surface of the second groove and having an airfoil shape so that some of the water flows around the flow deflector to generate a second torque in a second direction opposite the first direction.

Additional aspects further comprise wherein the airfoil has a positive camber.

Additional aspects further comprise wherein a magnitude of the second torque increases as the flow rate of the water out of the nozzle increases.

Additional aspects further comprise wherein the increase in the flow rate of the water out of the nozzle is caused by an increase in water pressure.

Additional aspects further comprise wherein the increase in the flow rate of the water out of the nozzle is caused by an increase in an orifice size of the nozzle.

Another aspect of the disclosure is a sprinkler assembly that includes a water inlet, a frame connected to the water inlet, a nozzle in fluid communication with the water inlet and configured to direct water out of the nozzle along a nozzle axis, and a distribution plate. The distribution plate can include a first plurality of grooves configured to deflect some of the water from the nozzle and generate a first torque in a first direction to cause the distribution plate to tilt and rotate relative to the nozzle axis, a second plurality of grooves configured to deflect some of the water from the nozzle, and a plurality of flow deflectors positioned in the second plurality of grooves to generate a second torque in a second direction opposite the first direction.

Additional aspects further comprise wherein the first plurality of grooves and the second plurality of grooves are substantially uniformly distributed on an upstream side of the distribution plate.

Additional aspects further comprise wherein the plurality of flow deflectors are positioned at a similar radial location.

Additional aspects further comprise wherein a first portion of the plurality of flow deflectors is positioned at a first radial location on the distribution plate and a second portion of the plurality of flow deflectors is positioned at a second radial location on the distribution plate different than the first radial location.

Additional aspects further comprise wherein a first portion of the plurality of flow deflectors have a different size or shape than a size or shape of a second portion of the plurality of flow deflectors.

Additional aspects further comprise wherein at least some of the plurality of flow deflectors comprise camber with a flat bottom surface.

Additional aspects further comprise wherein at least some of the plurality of flow deflectors have an airfoil shape.

Additional aspects further comprise wherein at least some of the plurality of flow deflectors comprise a top surface and a bottom surface that is parallel to the top surface.

Additional aspects further comprise wherein at least some of the plurality of flow deflectors comprise a wedge shape.

Another aspect of the disclosure is a distribution plate for an irrigation device that includes a first groove configured to receive water at a drive inlet and deflect a first portion of the water along an arcing flowpath extending radially away from an axis of the irrigation device to a drive outlet that generates a first torque in a first direction, a second groove configured to receive water at a spray inlet and deflect a second portion of the water along a radial flowpath to a spray outlet, and a flow deflector in the second groove that generates a second torque in a second direction opposite the first direction when the second portion of the water flows past.

Additional aspects further comprise wherein the flow deflector projects upwardly from a bottom surface of the second groove.

Additional aspects further comprise wherein the flow deflector has an airfoil shape.

Additional aspects further comprise wherein the airfoil has a positive camber.

Additional aspects further comprise wherein a magnitude of the second torque increases as the flow rate of the water out of the nozzle increases.

Additional aspects further comprise wherein the increase in the flow rate of the water out of the nozzle is caused by an increase in water pressure.

Additional aspects further comprise wherein the increase in the flow rate of the water out of the nozzle is caused by an increase in an orifice size of the nozzle.

Additional aspects further comprise wherein the second torque is less than the first torque so that overall the distribution plate rotates in the first direction.

Additional aspects further comprise a plurality of the first grooves and a plurality of the second grooves.

Additional aspects further comprise wherein the second portion of the water passes over and around the flow deflector to produce the second torque.

Additional aspects further comprise a drive brake assembly configured to resist rotation of the distribution plate.

Additional aspects further comprise wherein the drive brake assembly is configured as a viscous shear brake.

### BRIEF DESCRIPTION OF THE DRAWINGS

Various embodiments are depicted in the accompanying drawings for illustrative purposes and should in no way be interpreted as limiting the scope of the embodiments. In addition, various features of different disclosed embodiments can be combined to form additional embodiments, which are part of this disclosure.

FIG. 1 is a perspective view of an irrigation system using exemplary rotating sprinklers according to principles of the present disclosure.

FIG. 2 is a perspective view of one of the sprinklers of FIG. 1 comprising a distribution plate with an exemplary flow deflector according to principles of the present disclosure.

FIG. 3 is a cross-sectional side view of the sprinkler of FIG. 2, as viewed along cut-plane through a longitudinal axis of the sprinkler, illustrating a flow of water through the sprinkler according to the principles of the present disclosure.

FIG. 4 is an exploded perspective view of the sprinkler of FIG. 2 according to the principles of the present disclosure.

FIG. 5 is a perspective view of an exemplary distribution plate of the sprinkler according to the principles of the present disclosure.

FIG. 6 is a side view of the exemplary distribution plate of FIG. 5 according to the principles of the present disclosure.

FIGS. 7A-7D are top views of the exemplary distribution plate of FIG. 5 illustrating streams of water flowing through grooves of the distribution plate according to the principles of the present disclosure.

FIGS. 8A-8C are top and perspective views of an exemplary flow deflector of the distribution plate of FIG. 5.

FIGS. 9A-9C are top views of other exemplary flow deflectors for use with a distribution plate according to the principles of the present disclosure.

FIGS. 10 and 11 are side views of other sprinklers with the exemplary distribution plate of FIG. 5 according to the principles of the present disclosure.

FIGS. 12-14 are top views of the exemplary distribution plate of FIG. 5 including various numbers of flow deflectors according to the principles of the present disclosure.

FIG. 15 is a top view of another exemplary distribution plate including flow deflectors oriented in first and second directions and first and second locations of the grooves according to the principles of the present disclosure.

### DETAILED DESCRIPTION

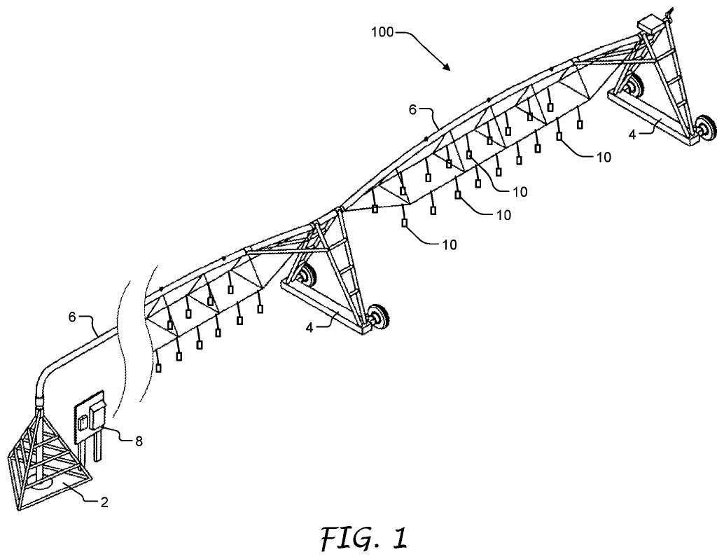

FIG. 1 is a perspective view of an exemplary irrigation system 100 for use within an agricultural setting such as, for example, a center pivot irrigated field. Irrigation system 100 is used for illustrative purposes only and may include any known irrigation system for any known uses, now or contemplated for commercial, agricultural, mining, residential, or other uses. Irrigation system 100 may include a center pivot 2, a moving base 4, and a pipe 6 to deliver water from a water source such as a well, aquifer, storage tank, or municipal system. Controller 8 may control flow of water from the center pivot 2 into the pipe 6 as well as one or more motors of the moving base 4 to rotate about the center pivot 2. Irrigation system 100 may utilize various types of sprinklers 10 which are fluidly coupled with the pipe 6 to deliver water to plants, crops, grass, dusty areas, or any other known uses in which sprinklers 10 may be employed.

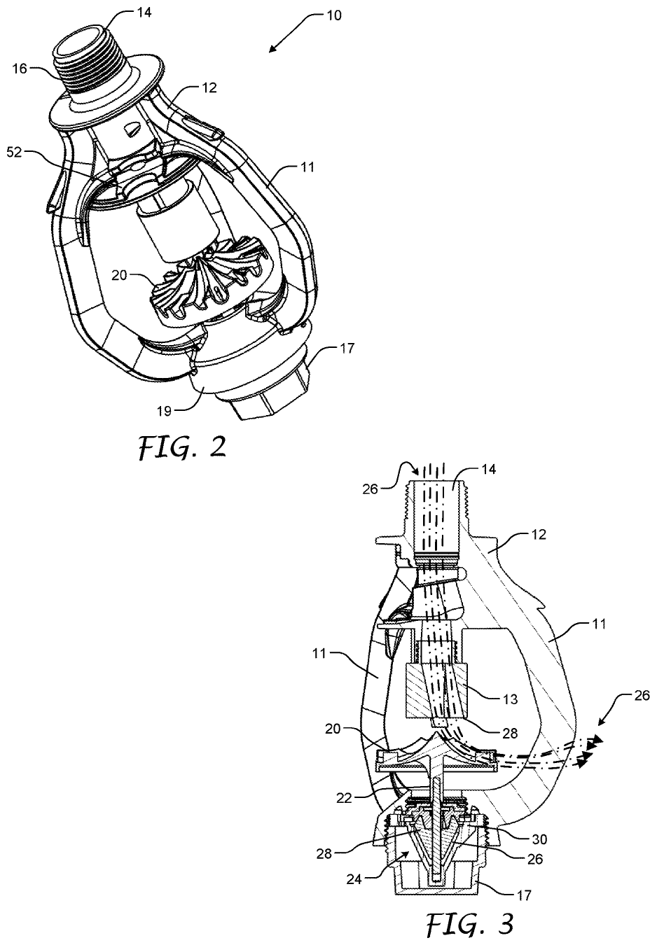

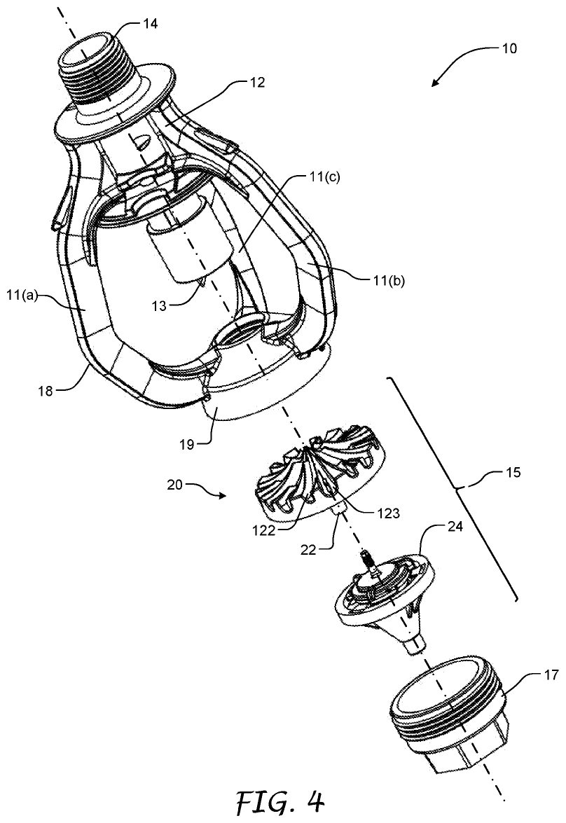

FIGS. 2-4 illustrate an exemplary sprinkler 10 with a distribution plate 20. The sprinkler 10 can include a water inlet 14. The water inlet 14 defines an upstream end of the sprinkler 10. The water inlet 14 can be connected to a frame or bracket 11. In some embodiments, the water inlet 14 is formed as a part of the frame or bracket 11. In some embodiments, the inlet 14 can be a separate piece that is removably or permanently attached to the frame or bracket 11. In some embodiments, the inlet 14 can be formed integrally with the frame or bracket 11. In some embodiments, the inlet 14 can be at least partially surrounded by threads 16. The inlet threads 16 can be screwed into a water supply line such as pipe 6 on irrigation system 100. In some instances, a pressure regulator can be positioned between the water supply line and the sprinkler 10. The threaded inlet 16 can also be screwed into an outlet of the pressure regulator. Other attachment methods, including, but not limited to, glued connections, bayonet mounts, snap rings, keys, or collars can be used to secure the sprinkler 10 to either a water supply line or a pressure regulator.

A shroud 12 can cover an upstream area of the bracket 11. A nozzle 13 can extend at least partially beyond a downstream end of the water inlet 14. The nozzle 13 may removably couple with the shroud 12. In some embodiments, the shroud 12 can act as an umbrella to protect components, including but not limited to moving components that are located under the shroud 12. In some embodiments, the shroud 12 can include a receiving station 52 to hold a spare nozzle.

The bracket 11 can include one or more arms 11A-11C (for example, one, two, three, four, or more). In certain embodiments that include two or more arms 11A-11C, the two or more arms 11A-11C can be spaced apart from one another. As illustrated in FIGS. 2-5, the bracket 11 has three arms 11A, 11B, and 11C. In certain embodiments, the one or more arms 11A-11C can have an outwardly bulging middle section 18. In certain embodiments, the one or more arms 11A-11C can be joined at one or both of their upstream and downstream ends with a collar 19, wherein the upstream end of the bracket 11 is closer to the water inlet 14 than the downstream end.

The sprinkler 10 can include a deflector assembly 15 supported by the bracket 11. The deflector assembly 15 can be surrounded by the one or more arms 11A-11C of the bracket 11 and/or a bearing housing 17. The bearing housing 17, which will be described in greater detail below, can be coupled to the bracket 11.

As illustrated, the deflector assembly 15 of the sprinkler 10 rotates. In certain embodiments, the deflector assembly 15 includes a distribution plate 20. The distribution plate 20 can be positioned downstream of the nozzle 13. In some embodiments, the nozzle 13 is configured to direct water onto the distribution plate 20. Water impingement on the distribution plate 20 can cause the deflector assembly 15 to rotate about a longitudinal axis of the sprinkler 10. Rotation of the deflector assembly 15, including the distribution plate 20, can allow water to be dispersed in different directions. Dispersing water in different directions can facilitate a more even distribution of water about an area of irrigation than a sprinkler without the deflector assembly 15.

The deflector assembly 15 may include a drive brake assembly 24. For example, the distribution plate 20 may be attached to a drive shaft 22 which couples with one or more features in the drive brake assembly 24. In certain embodiments, the drive brake assembly 24 resists rotation of the drive shaft 22. In certain embodiments, the drive brake assembly 24 may include a friction brake, a viscous shear brake with a silicone-or oil-based material, or any other brake which may act on the rotating drive shaft 22 to slow the rotational speed. As shown in FIG. 3, the drive brake assembly 24 is configured as a viscous shear brake. In certain embodiments, the viscous shear brake may include a chamber 26 formed between a shaft bearing 28 and a housing bearing 30. The shaft bearing 28 may be coupled with the drive shaft 22 and rotate with the drive shaft 22. The housing bearing 30 may be rigidly fixed within the bearing housing 17. Silicone or another viscous fluid in the chamber 26 may resist rotational motion of the shaft bearing 28 relative to the housing bearing 30 thus providing a braking force on the drive shaft 22. This braking force may slow the rotational velocity of the attached distribution plate 20 as water flow increases.

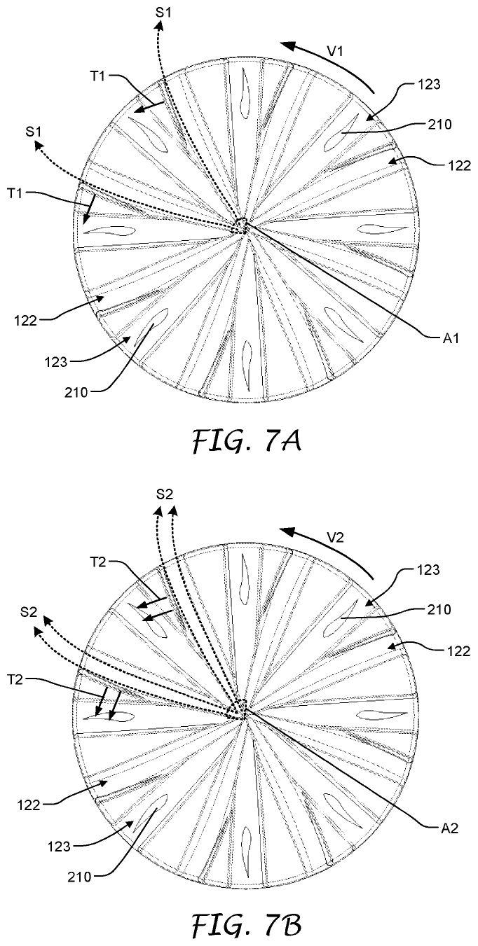

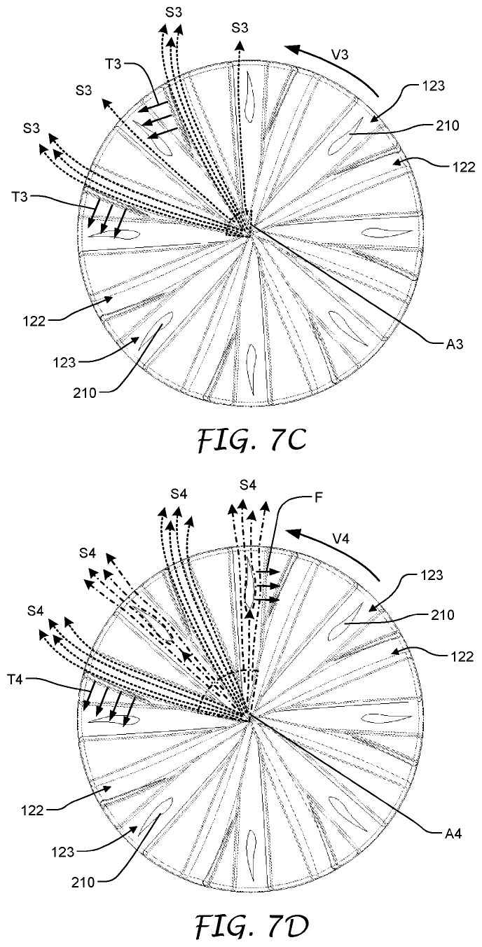

Continuing with FIG. 3, water flowing through the irrigation system 100 enters the inlet 14 as indicated by arrows at 26. The water passes into the nozzle 13 and exits through a nozzle orifice 28. Depending on the shape and size of the orifice 28, and a flow rate and/or pressure of the water in the irrigation system 100, different cross-sectional areas of water may impinge upon the distribution plate 20. In certain embodiments, the water impinges the distribution plate 20 in one or more areas A1-A4 shown in FIGS. 7A-7D near the axial center 125 before passing into one or more of grooves 122, 123 as describe further herein.

The one or more grooves 122, 123 channel the water exiting the nozzle 13 to be ejected in a controlled direction, radially outward from the sprinkler 10. In some embodiments, the one or more grooves 122, 123 can be radially angled to cause the deflector assembly 15 to rotate when the water from the nozzle 13 impinges on the distribution plate 20. In some embodiments, the one or more grooves 122, 123 can be curved. In some embodiments, the one or more grooves 122, 123 can be substantially straight. In some embodiments, such as shown in FIG. 13, the one or more grooves 122, 123 can be identical or substantially identical in shape. In certain embodiments, the one or more grooves 122, 123 can also be uniformly or substantially uniformly distributed on the upstream side of the distribution plate 20. In certain embodiments, the one or more grooves 122, 123 can include curvature in more than one plane to ensure laminar flow to maximize forces that cause the distribution plate 20 to rotate.

In some situations, the nozzle 13 may be a small nozzle which outputs less water at a lower pressure than a large nozzle. In other situations, the nozzle 13 may be a large nozzle which outputs more water at a higher pressure than the small nozzle. Various sizes of nozzles 13 may be necessary to provide water at various flows and pressures. Different distribution plates 20 must be matched with these nozzles 13 to ensure uniform distribution of water. For example, if the wrong distribution plate 20 is matched with a given nozzle 13, too much or too little water may impinge upon the distribution plate 20 causing stall in the case of too little flow or pressure or overspin in the case of too much flow or pressure.

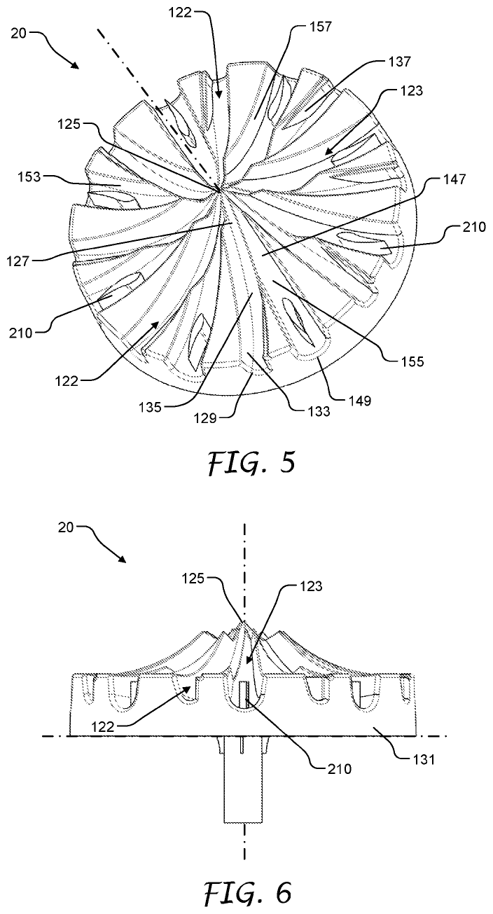

FIGS. 5 and 6 illustrate in greater detail an embodiment of the distribution plate 20 including features suitable for use with a wide range of nozzles 13 of varying flow and pressure. As shown in this embodiment, a plurality of first grooves 122 and a plurality of second grooves 123 radially extend from the center 125 of the distribution plate 20 through which a longitudinal axis passes. In certain embodiments, the first and second grooves 122, 123 are evenly spaced apart and alternately arranged such that each first groove 122 is followed by each second groove 123. Although eight first grooves 122 and eight second grooves 123 are shown, any number of first grooves 122 and any number of second grooves 123 may be present.

In certain embodiments, the first groove 122 includes a drive inlet 127 disposed near the center 125 and a drive outlet 129 disposed on an outer radial surface 131 of the distribution plate 20. In the illustrated embodiment, water enters the first groove 122 at the drive inlet 127 and flows along a first side wall 133, a bottom surface 135, and a second side wall 137 of the first groove 122. In the illustrated embodiment, the first groove 122 includes a sloping path from the center 125 to the outer radial surface 131 with the drive inlet 127 closer to the nozzle 13 along the direction of the longitudinal axis than the drive outlet 129. In the illustrated embodiment, the first groove 122 further includes curvature formed by an arcing path from the center 125 to the outer radial surface 131 with the drive outlet 129 radially offset from the drive inlet 127. In this manner, water flowing through the first groove 122 produces drive torque which drives the distribution plate 20 to rotate and tilt about the longitudinal axis as described in further detail below.

In the illustrated embodiment, the second groove 123 includes a spray inlet 147 disposed near the center 125 and a spray outlet 149 disposed on the outer radial surface 131 of the distribution plate 20. In the illustrated embodiment, water enters the second groove 123 at the spray inlet 147 and flows along a first side wall 153, a bottom surface 155, and a second side wall 157 of the second groove 123. In the illustrated embodiment, the second groove 123 includes a sloping path from the center 125 to the outer radial surface 131 with the spray inlet 147 closer to the nozzle 13 along the direction of the longitudinal axis than the spray outlet 149. In the illustrated embodiment, the second groove 123 further includes a radial path from the center 125 to the outer radial surface 131 with the spray outlet 149 radially aligned with the spray inlet 147. A flow deflector 210 projects upwardly from the bottom surface 155 at or near the spray outlet 149. Water flowing through the second groove 123 passes over and around the flow deflector 210 to produce a counter torque to the first torque TI as described in further detail below.

Referring now to FIGS. 7A-7D, dotted line arrows S1, S2, S3, and S4 illustrate streams(S) of water flowing from the nozzle 13 into the first and second grooves 122, 123 for four different flow conditions. Curved arrows V1, V2, V3, and V4 illustrate angular velocities (V) of the distribution plate 20 for the four different flow conditions. Tangential arrows T1, T2, T3, and T4 located along imagined radii of the distribution plate 20 illustrate torques (T) applied to the distribution plate 20 due to the four different flow conditions. Quarter-circle dotted line areas A1, A2, A3, and A4 illustrate four areas (A) near the center 125 into which water flowing from the nozzle 13 impinges upon the distribution plate 20 and enters one or more of the first and second grooves 122, 123 for the four different flow conditions. Fourth area A4 is greater in size than third area A3 which is greater in size than second area A2 which is greater in size than first area A1, thus A4>A3>A2>A1.

FIG. 7A illustrates a first flow condition in which water exiting the nozzle 13 impinges the distribution plate 20 in the first area A1 near the center 125. The first flow condition may be associated with a first nozzle with orifice 28 corresponding in size and shape to the first area A1, a first flow rate, or a first flow pressure, any of which may cause the water exiting the nozzle 13 to impinge upon the distribution plate 20 mostly in the first area A1.

FIG. 7B illustrates a second flow condition in which water exiting the nozzle 13 impinges the distribution plate 20 in the second area A2 near the center 125. The second flow condition may be associated with a second nozzle with orifice 28 corresponding in size and shape to the second area A2, a second flow rate, or a second flow pressure, any of which may cause the water exiting the nozzle 13 to impinge upon the distribution plate 20 mostly in the second area A2. The second flow rate is greater than the first flow rate. The second flow pressure may be greater than the first flow pressure.

FIG. 7C illustrates a third flow condition in which water exiting the nozzle 13 impinges the distribution plate 20 in the third area A3 near the center 125. The third flow condition may be associated with a third nozzle with orifice 28 corresponding in size and shape to the third area A3, a third flow rate, or a third flow pressure, any of which may cause the water exiting the nozzle 13 to impinge upon the distribution plate 20 mostly in the third area A3. The third flow rate is greater than the second flow rate. The third flow pressure may be greater than the second flow pressure.

FIG. 7D illustrates a fourth flow condition in which water exiting the nozzle 13 impinges the distribution plate 20 in the fourth area A4 near the center 125. The fourth flow condition may be associated with a fourth nozzle with orifice 28 corresponding in size and shape to the fourth area A4, a fourth flow rate, or a fourth flow pressure, any of which may cause the water exiting the nozzle 13 to impinge upon the distribution plate 20 mostly in the fourth area A4. The fourth flow rate is greater than the third flow rate. The fourth flow pressure may be greater than the third flow pressure.

The motion of the distribution plate 20 depends on the geometric features of the first groove 122 and the second groove 123. For example, the first groove 122 may include significant curvature which produces driving and propulsion torques T1, T2, T3, and T4 as the streams S1, S2, S3, and S4 of the water apply forces on the sidewall of the first groove 122, causing the distribution plate 20 to rotate clockwise with velocities V1, V2, V3, and V4, respectively. In certain embodiments, the second groove 123 includes little or no curvature and produces little or no driving or propulsion torque. However, the flow deflector 210 in the second groove 123 may produce a counter force F when stream S4 fills the second groove 123 and flows into and/or around the flow deflector 210.

In FIG. 7A, the first flow condition causes a first stream S1 to flow into area A1 which encompasses a small portion of the drive inlets 127 of two first grooves 122. The water in the first stream S1 applies a first torque and/or propulsion force (T1) along the lengths of sidewalls of the two first grooves 122 and as the first stream S1 exits the two first grooves 122. This causes the distribution plate 20 to rotate at a first angular velocity V1 in a counterclockwise direction. In FIG. 7B, the second flow condition causes a second stream S2 to flow into area A2 which encompasses all of the drive inlets 127 of two first grooves 122. The water in the second stream S2 applies a second torque and/or propulsion force (T2) greater than the first force T1 along the lengths of sidewalls of the first grooves 122 and as the second stream S2 exits the first grooves 122. This causes the distribution plate 20 to rotate at a second angular velocity V2 that is greater than the first angular velocity VI in a counterclockwise direction. In FIG. 7C, the third flow condition causes a third stream S3 to flow into area A3 which encompasses all of the drive inlets 127 of two first grooves 122 and a small portion of the spray inlets 147 of two second grooves 123. The water in the third stream S3 applies a third torque and/or propulsion force (T3) greater than the second force T2 along the lengths of sidewalls of the first grooves 122 and as the third stream S3 exits the first grooves 122. This causes the distribution plate 20 to rotate at a third angular velocity V3 that is greater than the second angular velocity V2 in a counterclockwise direction. A small portion of the third stream S3 may flow into, past, or around the flow deflectors 210 in the second grooves 123. However, the third stream S3 does not include enough water flow or pressure to produce any counter force F. In FIG. 7D, the fourth flow condition causes a fourth stream S4 to flow into area A4 which encompasses all of the drive inlets 127 of two first grooves 122 and all of the spray inlets 147 of two second grooves 123. The water in the fourth stream S4 applies a fourth torque and/or propulsion force (T4), which may be greater than the third force T3, along the lengths of sidewalls of the first grooves 122 and as the fourth stream S4 exits the first grooves 122. This causes the distribution plate 20 to rotate at a fourth angular velocity V4 that is greater than the third angular velocity V3 in a counterclockwiseh direction. The fourth stream S4 flows into, past, and/or around the flow deflectors 210 in the second grooves 123. The fourth stream S4 includes enough water flow to produce a counter force F, causing a counter torque to be applied to the distribution plate 20 in the clockwise direction. The counter force F may assist the drive brake assembly 24 with maintaining the fourth angular velocity V4.

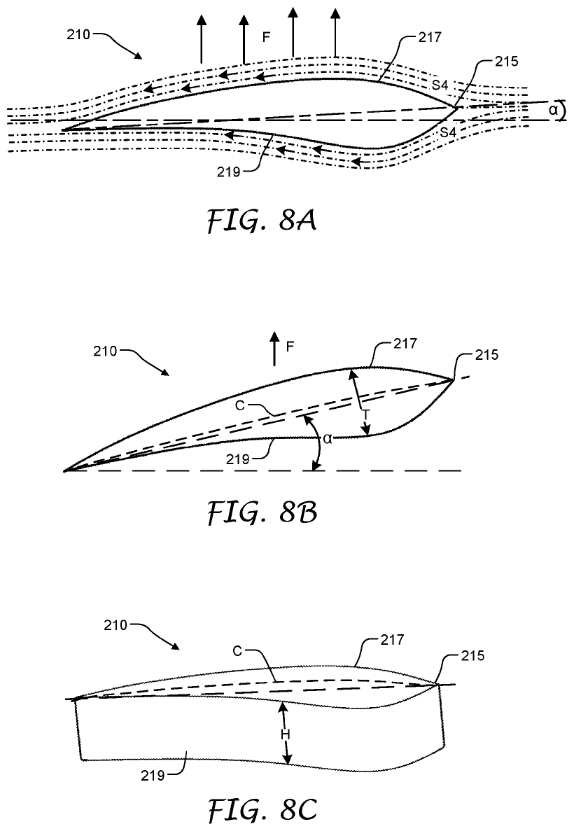

As shown in greater detail in FIGS. 8A-8C, the flow deflector 210 may include an airfoil shape with positive camber to produce the counter force F. In certain embodiments, each flow deflector 210 may be attached to or formed in the second groove 123. As the fourth stream S4 meets a leading edge 215 of the flow deflector 210, the fourth stream S4 separates around a top surface 217 and a bottom surface 219 of the flow deflector 210. Camber causes the water to flow around the flow deflector 210 at different velocities, resulting in a negative pressure field on the top and a positive pressure field at the bottom. This pressure difference contributes to the counter or upward force F. In addition, the flow deflector 210 may be angled relative to the radial flow of the fourth stream S4 by an angle of attack α. The counter or upward force F produces the counter torque which is applied in the clockwise direction on the distribution plate 20.

As the inlet fluid velocity profile increases and a higher flow enters the spray inlet 147, the flow deflector 210 will produce the counter or upward force F with greater magnitude. The result is that the flow deflector 210 produces more counter torque as the nozzles 13 increase in size and/or flow. This will allow for less deviation in the angular velocity with a wide array of nozzle 13 sizes and pressures. The amount or magnitude of the counter force F produced by an airfoil-shaped flow deflector 210 may be adjusted by configuring the geometric characteristics accordingly to produce specific amounts of force for varying nozzle 13 sizes and pressures. For example, adjusting maximum thickness T (FIG. 8B), mean camber line C (FIGS. 8B and 8C), the angle of attack α (FIGS. 8A and 8B), or the height H (FIG. 8C) will affect the amount of counter force F produced by the flow deflector 210.

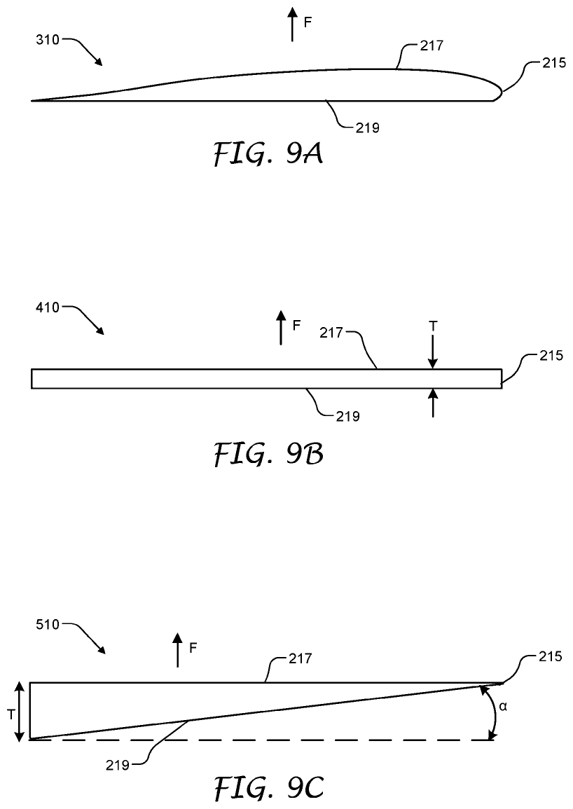

FIGS. 9A-9C illustrate other embodiments of flow deflectors 310, 410, 510 which may or may not include camber C. For example in FIG. 9A, the flow deflector 310 may include camber with a flat bottom surface 219. In FIG. 9B, the flow deflector 410 includes a substantially flat top surface 217 and a substantially flat bottom surface 219 with the two surfaces being parallel and separated by thickness T. In these examples, the angle of attack α of the flow deflector 310, 410 alone may be adjusted to produce the counter force F. In FIG. 9C, the flow deflector 510 includes a wedge shape with substantially flat top surface 217 and a substantially flat bottom surface 219 with the two surfaces being non-parallel and separated by a thickness T at one end and intersecting at the other end. The angle formed between the two non-parallel surfaces may be adjusted to produce the counter force F.

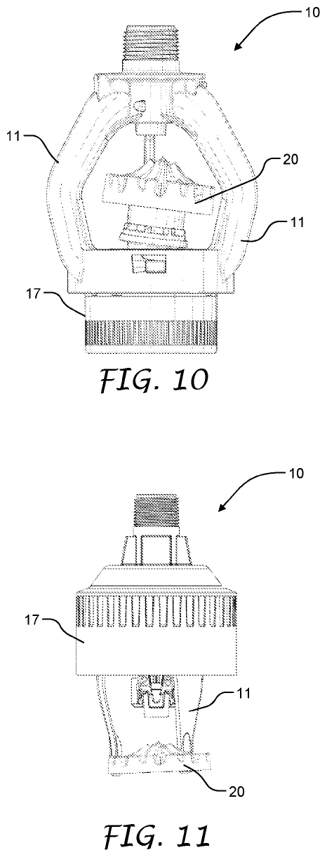

FIGS. 10 and 11 illustrate other embodiments of sprinklers 10 including distribution plates 20 with flow deflectors 210. In FIG. 10, the distribution plate 20 tilts as it rotates about a pivot point inside the bearing housing 17. In FIG. 11, the distribution plate 20 is attached to the bracket 11 which may tilt and pivot relative to the bearing housing 17.

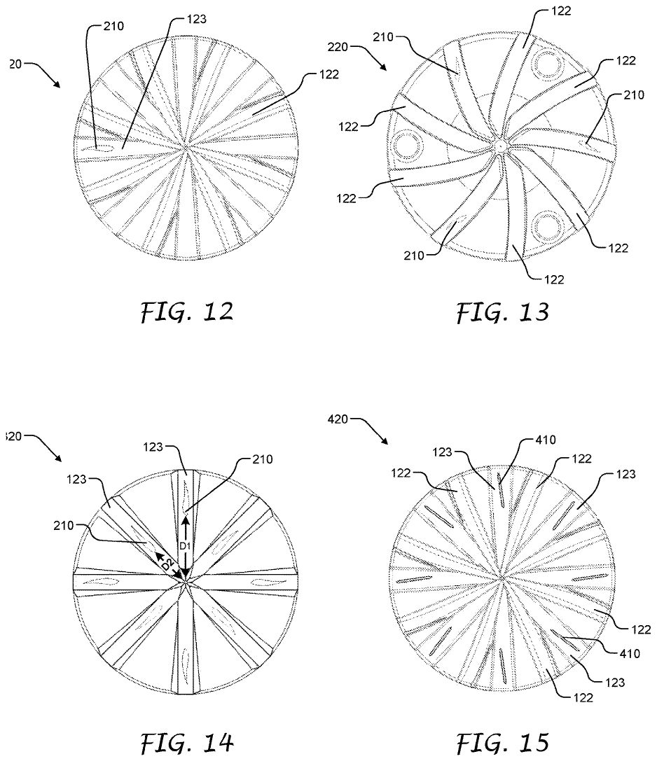

FIG. 12 illustrates an example of a distribution plate 120 that is similar to the distribution plate 20 but includes a single flow deflector 210 in a single second groove 123. Although it may be more effective to evenly distribute flow deflectors 210 throughout, as in the distribution plate 20 from above, in principle operation, a single flow deflector 210 may provide some amount of counter torque to the distribution plate 120 to maintain angular velocity caused by flow through the first grooves 122.

FIG. 13 illustrates an example of a distribution plate 220 with nine identical grooves 122 similar to the first grooves 122 above. Here, every third groove of the first grooves 122 includes a flow deflector 210 disposed at a similar radial location as in the distribution plate 20 above. However, each flow deflector 210 is oriented at an angle of attack α that is slightly downward and which could be used to produce additional positive force in the direction of rotation caused by the first grooves 122.

FIG. 14 illustrates an example of a distribution plate 320 with eight identical grooves 123 similar to the second grooves 123 above. Here, every groove 123 includes a flow deflector 210. Half of the flow deflectors 210 are positioned at a similar radial location, D1, as in the distribution plate 20 above. The other half of the flow deflectors 210 are positioned at a radial location, D2, which is closer to the center 125 of the distribution plate 20. Each flow deflector 210 is oriented at the same angle of attack α similar to the distribution plate 20.

FIG. 15 illustrates an example of a distribution 420 with first and second grooves 122, 123 and flow deflectors 410. The flow deflectors 410 are disposed at an angle of attack α relative to the radial flow of the stream of water flowing through the first grooves 123 to produce a lift force F.

In other embodiments, the inlets, grooves, and nozzle areas may be configured in various ways to include one or more flow deflectors 210 which may increase or decrease rotational torque on the distribution plate 20. In certain embodiments, the first grooves 122 which employ a curvature to provide forces such as T1-T4 may be replaced with straight grooves (similar to second grooves 123) but which have drive inlets 127 in the same location as the first grooves 122. The flow deflectors 210 may provide a force which drives the distribution plate 20 in the counterclockwise direction.

### Terminology

Although certain embodiments and examples are disclosed herein, inventive subject matter extends beyond the examples in the specifically disclosed embodiments to other alternative embodiments and/or uses, and to modifications and equivalents thereof. Thus, the scope of the claims appended hereto is not limited by any of the particular embodiments described above. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

For expository purposes, the term “horizontal” as used herein is defined as a plane parallel to the plane or surface of the floor or ground of the area in which the device being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Although the sprinkler has been disclosed in the context of certain embodiments and examples, it will be understood by those skilled in the art that the sprinkler and subassemblies extends beyond the specifically disclosed embodiments to other alternative embodiments and/or uses of the embodiments and certain modifications and equivalents thereof. For example, some embodiments are configured to operate oriented such that the distribution plate is positioned above the nozzle and the nozzle directs water upward. Accordingly, it is intended that the scope of the sprinkler herein-disclosed should not be limited by the particular disclosed embodiments described above, but should be determined only by a fair reading of the claims that follow.

1. A sprinkler assembly comprising:
a water inlet;
a frame connected to the water inlet;
a nozzle in fluid communication with the water inlet and positioned downstream of the water inlet, the nozzle configured to direct water out of the nozzle along a nozzle axis;
a bearing positioned downstream of the nozzle and supported by the frame; and
a deflector assembly between the nozzle and the bearing and being supported by the bearing, the deflector assembly including a distribution plate configured to deflect water from the nozzle, the distribution plate being positioned downstream of the nozzle and including:
a first groove configured to receive water from the nozzle at a drive inlet and deflect a first portion of the water along an arcing flowpath extending radially away from the nozzle axis to a drive outlet that generates a first torque in a first direction;
a second groove configured to receive water from the nozzle at a spray inlet and deflect a second portion of the water along a radial flowpath to a spray outlet; and
a flow deflector in the second groove that generates a second torque in a second direction opposite the first direction when the second portion of the water flows past.

2. The sprinkler assembly of claim 1, wherein the second torque is less than the first torque so that overall the distribution plate rotates in the first direction.

3. (canceled)

4. The sprinkler assembly of claim 1, wherein the flow deflector projects upwardly from a bottom surface at or near the spray outlet of the second groove.

5. The sprinkler assembly of claim 1, wherein the second portion of the water passes over and around the flow deflector to produce the second torque.

6. The sprinkler assembly of claim 1, further comprising a shroud covering at least a portion of the frame.

7. (canceled)

8. (canceled)

9. The sprinkler assembly of claim 1, wherein the frame comprises a plurality of arms supporting the bearing.

10. The sprinkler assembly of claim 1, wherein the distribution plate is configured to rotate and tilt about the nozzle axis, and wherein the distribution plate is configured to disperse water in different directions to facilitate a more even water distribution.

11. The sprinkler assembly of claim 1, further comprising a drive brake assembly configured to resist rotation of the distribution plate.

12. The sprinkler assembly of claim 11, wherein the drive brake assembly is configured as a viscous shear brake.

13. A sprinkler assembly comprising:
a water inlet;
a frame connected to the water inlet;
a nozzle in fluid communication with the water inlet and positioned downstream of the water inlet, the nozzle configured to direct water out of the nozzle along a nozzle axis; and
a distribution plate configured to deflect water exiting the nozzle, the distribution plate comprising:
a first groove configured to receive some of the water from the nozzle and generate a first torque in a first direction, and
a second groove comprising a flow deflector, the flow deflector projecting upwardly from a bottom surface of the second groove and having an airfoil shape so that some of the water flows around the flow deflector to generate a second torque in a second direction opposite the first direction.

14. The sprinkler assembly of claim 13, wherein the airfoil has a positive camber.

15. The sprinkler assembly of claim 13, wherein a magnitude of the second torque increases as the flow rate of the water out of the nozzle increases.

16. The sprinkler assembly of claim 15, wherein the increase in the flow rate of the water out of the nozzle is caused by an increase in water pressure.

17. The sprinkler assembly of claim 15, wherein the increase in the flow rate of the water out of the nozzle is caused by an increase in an orifice size of the nozzle.

18. A sprinkler assembly comprising:
a water inlet;
a frame connected to the water inlet;
a nozzle in fluid communication with the water inlet and configured to direct water out of the nozzle along a nozzle axis; and
a distribution plate comprising:
a first plurality of grooves configured to deflect some of the water from the nozzle and generate a first torque in a first direction to cause the distribution plate to tilt and rotate relative to the nozzle axis,
a second plurality of grooves configured to deflect some of the water from the nozzle, and
a plurality of flow deflectors positioned in the second plurality of grooves to generate a second torque in a second direction opposite the first direction.

19. The sprinkler assembly of claim 18, wherein the first plurality of grooves and the second plurality of grooves are substantially uniformly distributed on an upstream side of the distribution plate.

20. The sprinkler assembly of claim 18, wherein the plurality of flow deflectors are positioned at a similar radial location.

21. The sprinkler assembly of claim 18, wherein a first portion of the plurality of flow deflectors is positioned at a first radial location on the distribution plate and a second portion of the plurality of flow deflectors is positioned at a second radial location on the distribution plate different than the first radial location.

22. The sprinkler assembly of claim 18, wherein a first portion of the plurality of flow deflectors have a different size or shape than a size or shape of a second portion of the plurality of flow deflectors.

23. (canceled)

24. (canceled)

25. (canceled)

26. The sprinkler assembly of claim 18, wherein at least some of the plurality of flow deflectors comprise a wedge shape.

27-38. (canceled)
